(19) United States
(12) Patent Application Publication
(10) Pub. No.: US 2026/0170817 A1
(43) Pub. Date: Jun. 18, 2026

(54) MODEL PRE-TRAINING FOR USER INTERFACE NAVIGATION

(71) Applicant: Microsoft Technology Licensing, LLC, Redmond, WA (US)

(72) Inventors: Xiaoyi ZHANG, Redmond, WA (US); Yuwang WANG, Redmond, WA (US); Zhizheng ZHANG, Redmond, WA (US); Wenxuan XIE, Redmond, WA (US); Yan LU, Redmond, WA (US)

(73) Assignee: Microsoft Technology Licensing, LLC, Redmond, WA (US)

(21) Appl. No.: 19/124,342

(22) PCT Filed: Nov. 29, 2023
(86) PCT No.: PCT/US2023/081484

§ 371 Date: Apr. 25, 2025

(30) Foreign Application Priority Data
Dec. 13, 2022 (CN) 202211601686.0

(51) Int. Cl. G06V 10/82; G06F 18/214; G06N 20/00

(52) U.S. Cl. CPC G06V 10/82; G06F 18/214; G06N 20/00

(57) ABSTRACT

According to implementations disclosed herein, a solution for model pre-training for user interface navigation is provided. In the solution, a feature extraction model is obtained, configured to extract a feature representation related to user interface (UI) navigation. Navigation paths in a UI set are obtained, a navigation path comprising UIs and corresponding to a navigation task. UI descriptions and task descriptions corresponding to the navigation paths are obtained, with a UI description describing UI elements in UIs in a navigation path and a task description describing the navigation task corresponding to the navigation path. Based on a correspondence between the UI descriptions, task descriptions, and navigation paths, pre-training of the feature extraction model is performed. By introducing training data at navigation-path level to perform model pre-training, the model can directly learn knowledge representations related to navigation tasks. The pre-trained model can be easily generalized to downstream navigation tasks.

### BACKGROUND

Various websites and applications (APP) have become common tools for exchanging information and implementing functions in production and in daily life. User interfaces (UIs) of websites and APPs contain rich and varied graphical and text information. The interaction with UIs is almost indispensable when browsing websites and using applications. By accomplishing a series of UI navigation tasks, users can perform corresponding operations and achieve various tasks and objectives.

### SUMMARY

According to implementations of the subject matter described herein, a solution for model pre-training for user interface navigation is provided. According to the solution, a feature extraction model is obtained which is configured to extract a feature representation related to user interface (UI) navigation. A plurality of navigation paths in a UI set are obtained, a navigation path comprising a plurality of UIs in the UI set and corresponding to a navigation task. UI descriptions and task descriptions corresponding to the plurality of navigation paths are obtained, respectively, a UI description being used to describe UI elements comprised in a plurality of UIs in a navigation path, and a task description being used to describe the navigation task corresponding to the navigation path. Based on a correspondence between the UI descriptions, the task descriptions, and the plurality of navigation paths, pre-training of the feature extraction model is performed. By introducing the training data at the navigation path level to perform pre-training of the model, the model can directly learn knowledge representations related to navigation tasks. The pre-trained model can be easily generalized to various downstream practical navigation tasks.

The Summary is provided to introduce a selection of concepts in a simplified form that are further described below in the Detailed Description. The Summary is neither intended to identify key features or essential features of the subject matter described herein, nor is it intended to be used to limit the scope of the subject matter described herein.

### BRIEF DESCRIPTION OF THE DRAWINGS

FIG. 1 illustrates a block diagram of an example environment in which various implementations of the subject matter described herein can be implemented;

FIG. 2 illustrates a schematic diagram of architecture of a pre-training system in accordance with some implementations of the subject matter described herein;

FIG. 3 illustrates a schematic diagram of an example navigation graph in accordance with some implementations of the subject matter described herein;

FIG. 4 illustrates a schematic diagram of a navigation path in accordance with some implementations of the subject matter described herein;

FIG. 5 illustrates a flowchart of a process for model pre-training in accordance with some implementations of the subject matter described herein; and

FIG. 6 illustrates a schematic block diagram of an electronic device in which various implementations of the subject matter described herein can be implemented.

Throughout the drawings, the same or similar reference symbols refer to the same or similar elements.

### DETAILED DESCRIPTION OF EMBODIMENTS

The subject matter described herein will now be described with reference to some example implementations. It is to be understood that these implementations are described only for the purpose of illustration and help those skilled in the art to better understand and thus implement the subject matter described herein, without suggesting any limitations to the scope of the subject matter described herein.

As used herein, the term “includes” and its variants are to be read as open terms that mean “includes but is not limited to.” The term “based on” is to be read as “based at least in part on.” The terms “an implementation” and “one implementation” are to be read as “at least one implementation.” The term “another implementation” is to be read as “at least one other implementation.” The term “first,” “second,” and the like may refer to different or the same objects. Other definitions, either explicit or implicit, may be included below.

As used herein, a set of elements, an element set, or similar expressions may include one or more such elements. This set of elements may be ordered or unordered. For example, “a set of UI elements” may include one or more UI elements; “a set of tokens” can include one or more tokens.

As used herein, the term “UI element” refers to an interface component in a UI presented to the user, which can be set as any appropriate granularity for human-computer interaction. For example, a UI element may include but is not limited to an image, text, an icon, a button, a drop-down menu, a search box, an input box, and so on. In some implementations, a UI element may be a basic and non-decomposable component of a UI.

As used herein, the term “UI navigation” or “navigation” refers to guidance of interactions for users of UI, to assist or replace the user in carrying out corresponding operations and realizing the required functions.

As used herein, the term “model” may learn an association between corresponding input and output from training data, and thus a corresponding output may be generated for a given input after the training. The generation of the model may be based on machine learning techniques. Deep learning (DL) is one of machine learning algorithms that processes the input and provides the corresponding output using a plurality of layers of processing units. A neural network model is an example of a deep learning-based model. As used herein, “model” may also be referred to as “machine learning model”, “learning model”, “machine learning network” or “learning network”, which are used interchangeably herein.

Generally, machine learning may roughly include three stages, i.e., a training stage, a test stage, and an application stage (also referred to as an interference stage). In the training stage, a given model may be trained using a large scale of training data, with parameter values being iteratively updated until the model can obtain, from the training data, consistent interference that meets an expected target. Through the training, the model may be considered as being capable of learning the association between the input and the output (also referred to as an input-to-output mapping) from the training data. The parameter values of the trained model are determined. In the test stage, test inputs are applied to the trained model to test whether the model can provide correct outputs, so as to determine the performance of the model. In the interference stage, the model may be utilized to process a practical input based on the parameter values obtained from the training and to determine the corresponding output.

User interface (UI), such as webpage, is a data form that people often face in human-computer interaction. Generally, in order to achieve various goals or complete tasks such as password change, shopping, browsing settings, and the like, users need to navigate among a series of UIs. With the development of machine learning technology, it is proposed to train models to perform navigation tasks. In general, the machine learning based solutions require a large number of manually labelled training data. It is typically difficult to obtain labelled data in the UI navigation scenarios. Currently, large pre-trained models have received extensive attention due to their strong generalization capabilities and efficient utilization of large-scale data. After the model has been pre-trained on large-scaled data, according to the specific requirements in different downstream tasks, a small amount of data are needed to fine-tune the pre-trained model, which can significantly improve the efficiency of the overall model learning and reduce the demand for labelled data of specific downstream tasks.

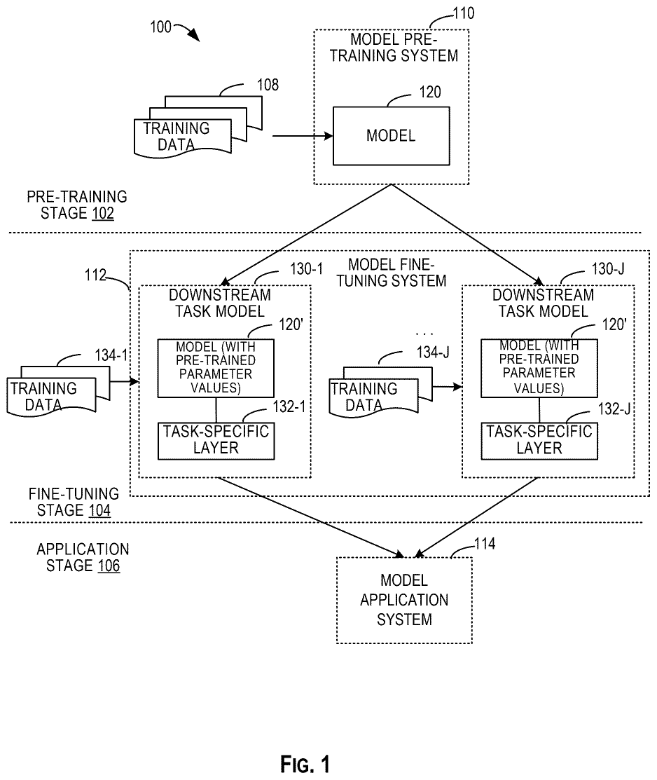

FIG. 1 illustrates a block diagram of an example environment 100 in which various implementations of the subject matter described herein can be implemented. In the environment of FIG. 1, three different stages of the model are shown, including a pre-training stage 102, a fine-tuning stage 104, and an application stage 106. After the pre-training or fine-tuning phase is completed, there can also be a testing phase, which is not shown in the figure.

In the pre-training stage 102, a pre-training system 110 is used to pre-train a machine learning model (i.e., a model 120) which can be configured to learn accurate representations of data (also known as feature representations of data) from training data 108. Before the pre-training, parameter values of model 120 may have initial values. The pre-training for the model 120 is performed with the training data 108. The parameter values of the model 120 may be updated and adjusted during the pre-training. After the pre-training, a model 120′ may be obtained. At this time, the parameter values of the model 120′ have been updated as pre-trained parameter values. In the embodiments of the subject matter described herein, the model 120′ may be used as a feature extraction model, which is configured to extract a feature representation of input data.

In the pre-training stage 102, the model 120 may learn a strong generalization capability from the large scale of training data 108. The pre-trained model 120′ may be provided to a model fine-tuning system 112 to be fine tune for different downstream tasks (hereinafter referred to as downstream tasks). In some implementations, for the different downstream tasks, the pre-trained model 120′ may be connected to different task-specific layers 132-1, . . . , 132-J to build different downstream task models 130-1, . . . , 130-J. This is because different downstream tasks require different outputs. The model 120′ may extract a feature representation of an input and provide it to a task-specific layer to generate an output for the corresponding task. Some examples of downstream tasks and their outputs will continue to be described below.

In the fine-tuning stage 104, according to the requirements of specific downstream tasks, corresponding training data 134-1, . . . , 134-J may be selected to fine tune the built downstream task models 130-1, . . . , 130-J, respectively. The corresponding model training algorithm is also adopted to update and adjust the parameters of the overall model. Since the model 120′ has learned a lot from the training data in the pre-training stage, a small amount of training data is needed in the fine-tuning stage 104 to derive a downstream task model that meets the expectation.

In some implementations, in the pre-training phase 102, one or more task-specific layers may have been built to pre-train the model 120 for a plurality of downstream tasks according to the requirements of the pre-training objectives. In this case, if a task-specific layer for use in a certain downstream task is the same as the task-specific layer built for the pre-training, the pre-trained model 120′ and the task-specific layer may be directly used to form the corresponding downstream task model. In this case, the downstream task model may not require fine-tuning, or only require fine-tuning of a small amount of training data.

In the application phase 106, the obtained downstream task model may be provided to one or more model application systems 114 for use. In the application phase 106, each downstream task model may be used to process a corresponding input in the practical scenario and provide a corresponding output.

In FIG. 1, the model pre-training system 110, the model fine-tuning system 112, and the model application system 116 may include any computing system with the computing capability, such as various computing devices/systems, terminal devices, servers, and the like. Terminal devices may include any type of mobile terminal, fixed terminal or portable terminal, including mobile phone, desktop computer, laptop computer, netbook computer, tablet computer, media computer, multimedia tablet, or any combination thereof, including accessories and peripherals of these devices or any combination thereof. Servers include but are not limited to mainframe, edge computing nodes, computing devices in cloud environment, and the like.

It would be appreciated that the components and arrangements in the environment 100 shown in FIG. 1 are only examples, and a computing system suitable for implementing the example implementations described in the subject matter described herein may include one or more different components, other components, and/or different arrangements. For example, although being illustrated as separate systems, the model pre-training system 110, the model fine-tuning system 112, and the model application system 116 may be integrated in the same system or device. The implementations of the subject matter described herein are not limited in this regard. The example implementations of the model training and model application will be further described with reference to the accompanying figures.

Given the strong generalization capability of the pre-trained model, it is expected that such pre-trained model may also be provided in the use case of UI navigation. As used herein, a UI may include a webpage in a website APP page, a document page or the like. Each UI may include one or more UI elements. One or more UI navigation tasks (also referred to as navigation tasks) may be conducted by interactions with the UI elements, so as to accomplish the expected functions of users. Such navigation tasks may include but are not limited to login, password changing, password retrieval, account registration, keyword search, cookie setting, add-to-cart, pop-up removing, and the like.

Some proposed pre-trained models for UI navigation mainly focus on the understanding of a single UI, to enable model the different modalities of UI elements in a single UI or between two consecutive UIs. In the scene of UI navigation, it is expected that the pre-trained model may acquire more knowledge about the practical navigation tasks in the pre-training stage, so as to automate the navigation tasks.

For a practical navigation task, it is more important to expand the modeling scope from one or two UIs to a navigation trace (also known as a “navigation path”). However, the model pre-training solution at the navigation trace level has never been explored.

According to example implementations of the subject matter described herein, a solution for model pre-training for UI navigation is proposed. In this solution, a UI set is built and a plurality of navigation paths are identified from the UI set, each navigation path involving a plurality of UIs and being considered to enable accomplishment of a corresponding navigation task. On the basis of a navigation path, a UI description and a task description corresponding to the navigation path are obtained. Pre-training of a feature extraction model is performed based on the correspondence between UI description and task description and a plurality of navigation paths. By introducing training data at the navigation path level in model pre-training, the model may directly learn the knowledge representations related to the navigation tasks. The pre-trained model can be easily generalized to various practical downstream navigation tasks.

Some example implementations of the subject matter described herein will be described in more detail below with reference to the accompanying drawings.

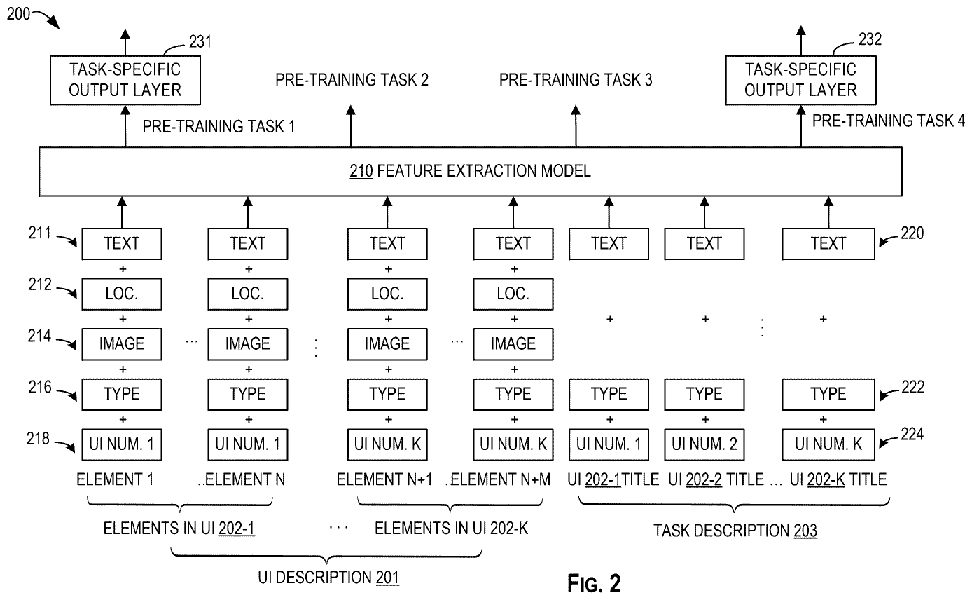

FIG. 2 illustrates a schematic block diagram of a model pre-training system 200 in accordance with some implementations of the subject matter described herein. The model pre-training system 200 is configured to perform pre-training of a feature extraction model 210. For example, the model pre-training system 200 may be implemented as the model pre-training system 110 in FIG. 1, and the feature extraction model 210 may accordingly be implemented as the model 120 in FIG. 1. In the implementations of FIG. 2, the feature extraction model 210 is configured to process the data involved in UI navigation to extract a feature representation related to UI navigation. Through the pre-training, the feature extraction model 210 may be capable of extracting, from the input data, feature representations that are more suitable for accurate predictions in UI navigation.

The feature extraction model 210 may be built with any model architecture suitable for processing text and/or visual data. In some implementations, the feature extraction model 210 may be based on Transformer architecture, such as a Bi-directional encoder representations (BERT) architecture. Of course, according to the requirements in practical applications, other model architecture, especially those suitable for pre-training, may be applicable for the feature extraction model 210.

In the pre-training, the building of the training data set is an important factor that has influence on the performance of the model. A large scale of high-quality training data are the basis of pre-training. In the implementations of the subject matter described herein, it is desired to build training data at the navigation path level. Specifically, a plurality of navigation paths are identified from a UI set. A navigation path here includes a plurality of UIs and corresponds to a navigation task. On the basis of the navigation task, a UI description and a task description corresponding to the navigation path are obtained. As shown in FIG. 2, a UI description 201 and a task description 203 corresponding to each navigation path are used as the training data of the feature extraction model 210. The UI description 201 is used to describe UI elements included in a plurality of UIs in the navigation path. The task description 203 is used to describe the navigation task corresponding to the navigation path.

Usually, a large number of UIs may be collected from various appropriate data sources, such as the Internet and mobile applications, to form the UI set. It is understood that the UIs (such as webpages) are usually linked to each other to form a website or multiple interconnected websites. From the perspective of the user, to reach a target UI for a specific navigation task, such as password changing, he/she may perform a series of operations to hop among a series of UIs until the task is accomplished. These UIs will form a trace, i.e., a navigation path. Inspired by the practical UI navigation scenarios, in the implementations of the subject matter described herein, instead of considering information in a single UI, navigation paths each formed by a plurality of UIs are considered as the foundation of pre-training data.

Considering the interconnections of the network, if the navigation paths are identified by means of random navigation (for example, randomly selecting a UI element in each UI leading to a next UI), a lot of navigation paths may be identified, many of which are meaningless and hard to provide knowledge representation related to the navigation tasks.

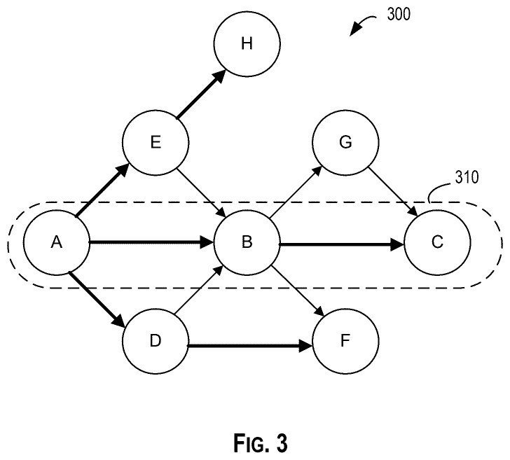

In some implementations, in order to efficiently identify the navigation paths from the UI set which includes a large number of UIs, the UI set may be built as a navigation graph, and a shortest path search algorithm may be applied to search for the navigation paths from the navigation graph. The navigation graph may include nodes corresponding to the UIs and directed edges between the nodes. A directed edge from a current node to a next node indicates that a UI corresponding to the next node may be navigated to from a UI corresponding to the current node. FIG. 3 shows a schematic diagram of an example navigation graph 300 according to some implementations of the subject matter described herein, where each node corresponds to a UI. Of course, the navigation graph 300 provides only a simplified graph for the purpose of example, and the practical navigation graph may be built as a more complex graph containing more nodes. In some implementations, a navigation graph may be built for a single website (application) or for multiple websites (applications) because the UIs within the website(s) may be linked between each other.

The inventors found that to accomplish a specific navigation task, a user often choose or intend to take the minimum steps to navigate from the initial UI to the last UI at which the navigation task can be completed. On the basis of those findings, to construct the navigation paths, it is expected that the navigation paths corresponding to respective navigation tasks are also the shortest navigation paths. Such shortest navigation paths are more likely to correspond to the practical navigation tasks, and thus can provide the model with the task-level knowledge in the pre-training stage.

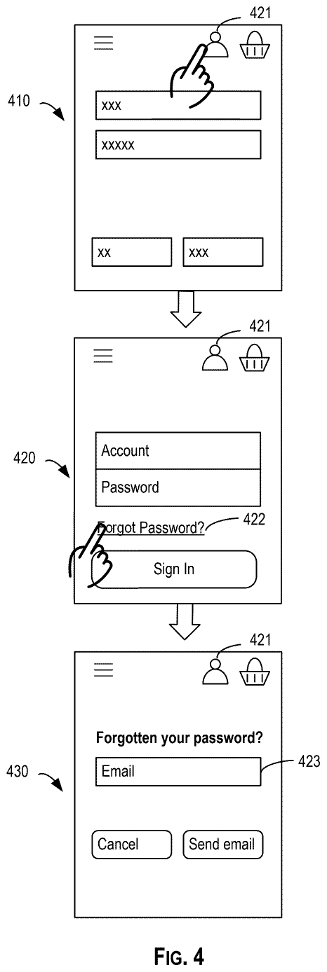

FIG. 4 shows a schematic diagram of a navigation path in accordance with some implementations of the subject matter described herein. In the example of FIG. 4, if the user forgets the password and wants to retrieve it, the user may click a UI element 421 in a UI 410 to hop to a UI 420 for user login. In the UI 420, the user may click a UI element 422 (Forgot Password) to continue to hop to a UI 430 for password resetting. For example, the password may be retrieved by entering the email address in a UI element 423 of the UI 430.

A shortest navigation path also corresponds to a shortest path between nodes in the navigation graph. For example, in the navigation graph 300 of FIG. 3, among all the possible paths from node A to node C, the path formed by A→B→C is the shortest path 310. Accordingly, the three UIs corresponding to nodes A, B, and C also form the expected navigation path. Therefore, in some implementations, one or more shortest paths may be searched from the navigation graph through the shortest path search algorithm. The UIs corresponding to the nodes in each shortest path may indicate the corresponding navigation path in the order indicated by the directed edges.

In some implementations, when searching for the navigation graphs, a given UI corresponding to a home page may be used as a starting node, and the shortest path search algorithm may be applied to search for the corresponding paths from the navigation graph. A home page here may be a home page of a website or an application. Of course, nodes corresponding to other UIs may also be specified as the starting nodes, which may be configured according to the actual requirements. In some implementations of path searching, the end nodes of the paths may also be specified, so as to search for the shortest paths from the start nodes to the end nodes. An end node may correspond to a UI at which the specific navigation task may be completed. For example, in order to complete the navigation tasks such as password change, password retrieval, and account registration, it needs to hop from the current UI to some specific UIs through one-step or multi-step navigation until the corresponding tasks are completed. In some implementations, an example of the shortest search path search algorithm is Dijkstra algorithm, but any other path search algorithms are also feasible.

In some implementations, both the hopping relationships between the UIs and the UI elements used to hop from the current UI to the next UI are recorded in the navigation graph. That is, a selected UI element in the current UI is recorded via which a next UI is hopped to from the current UI. In this way, for an identified navigation path, the selected UI elements in the UIs involved in the navigation path may also be recorded.

After the navigation paths are determined, the pre-training data may be built. The pre-training data at least includes a UI description 201 and a task description 203 corresponding to each navigation path. The UI description 201 is used to indicate a plurality of UIs involved in the corresponding navigation path from the UI element level. The task description 203 is used to indicate the navigation task to be accomplished in the corresponding navigation path from the whole path level. In the following, the task description 203 will first be discussed, and then the UI description 201.

Although it is believed that each identified navigation path corresponds to a certain navigation task to be accomplished, in the absence of manual annotation, it is in fact impossible to know exactly what the specific navigation task is. Although it is a feasible way to manually label each navigation path with the corresponding navigation task, considering the high cost of this method, it is expected to automatically obtain information to describe the navigation task corresponding to the navigation path. In some implementations, titles of the UIs involved in a navigation path are utilized to determine the task description of the navigation task corresponding to the navigation path. A title of a UI is usually a summarization of the UI. For example, the title of the login page UI is often “Login”, which provides high-level information about the current UI. Therefore, a task description 203 corresponding to a navigation path may at least include titles of a plurality of UIs involved in this navigation path. The combination of these titles may indicate the content of the navigation task.

As shown in FIG. 2, assuming that a navigation path includes K UIs, the task description 203 may include text information 220 corresponding to titles of UIs 202-1, 202-2, . . . , 202-K (collectively or individually referred to as UIs 202). The sequential combination of the text information 220 may be able to reflect the navigation task to be accomplished through the corresponding navigation path. The text information 220 corresponding to each title may be used as a fragment of the task description 203.

In some implementations, in addition to the titles of the UIs, the task description 203 may further indicate relative navigation numbers 224 of the plurality of UI titles in the navigation path. The respective UIs may be numbered in the navigation order from the start UI of the navigation path, such as Number 1, Number 2, . . . , Number K. In some implementations, the task description 203 may further indicate type information 222. The type information indicates a type of title.

In the pre-training, to be provided as the input of the feature extraction model 210, the input information may first be converted into an embedding representation, such as a multi-dimensional vector representation, to facilitate the subsequent processing by the model. In some implementations, the text information 220 of the title of each UI in the navigation path is converted into an embedding representation by a model that is suitable for processing text data, for example. The embedding representation may indicate the initial text features of the text information 220. The type information 222 and the relative navigation numbers 224 may be mapped to embedding representations through the corresponding embedding layer.

Note that it is assumed that a navigation path includes K UIs in FIG. 2. However, in the practical model training, considering that the number of UIs included in different navigation paths may be different, K may be a preconfigured number. For navigation paths with less than K UIs, paddings may be applied to include sufficient elements.

For the UI description 201 corresponding to a navigation path, the UI element set in each UI involved in the navigation path may be first extracted, and description information corresponding to each UI element in the UI element set is obtained. The UI description 201 may include description parts in units of UI elements. As shown in FIG. 2, the UI description 201 may include description parts corresponding to the elements from the UI 202-1 to the UI 202-K.

The UI elements in a UI may be extracted in various ways. For example, to obtain the UI elements in a webpage, a structure description file of the UI, such as the Hypertext Markup Language (HTML) metadata of the UI, may be retrieved. In some implementations, HTML may be parsed into a document object model (DOM) tree, and then corresponding UI elements may be identified from respective nodes in the DOM tree. For the applications in different operating systems, UI elements may also be extracted in a similar way. In some implementations, UI elements in a UI may be divided according to the hierarchical structure of the UI. For example, one UI element in a UI may be the overall UI corresponding to the highest level, and other UI elements are UI elements at a lower level than the overall UI, and so on, until the most fine-grained UI elements are obtained.

For each UI element in the UI, the UI description 201 may indicate text information 211 in the UI element. The text information 211 may be, for example, an attribute description of the UI element in the structure description file of the UI, such as HTML metadata. In some implementations, these attribute descriptions may be cascaded into a text sequence. The text sequence may be mapped into an embedding representation, for example, may be converted into an embedding representation by a model that is suitable for processing text data. The embedding representation may indicate the initial text features of the text information 211.

In some implementations, the UI description 201 may further indicate location information 212 of the UI elements in the corresponding UIs. A UI may be considered as a two-dimensional image or frame. In some implementations, a boundary box may be used to define locate a UI element in the UI, and the coordinates of the boundary box (for example, the coordinates of the upper, lower, left and right vertices of the boundary box in the two-dimensional space of the UI) may be determined as location information 212 of the UI element. In some implementations, the location information 212 may also be mapped into an embedding representation through the corresponding embedding layer.

In some implementations, the UI description 201 may further indicate image information 214 of UI elements. Different UI elements sometimes have different visual representations, which also facilitate the understanding of UI navigation. In some implementations, with a bounding box of a UI element determined, the image block corresponding to the UI element may be taken from the screenshot of the overall UI. In some implementations, an image block corresponding to a UI element may be provided to a model that is suitable for image processing to extract an image feature representation corresponding to the image block. The image feature representation is used as image information 214 in the UI description 201 and input to the feature extraction model 210.

In some implementations, the UI description 201 may further indicate type information 216 of the UI elements. A single UI or a plurality of UIs may contain different types of UI elements. For example, two UI elements with the same text (for example, “Login”) may have different types (e.g., one UI element is a unclickable label, and the other UI element is a clickable button). The type information 216 is introduced in the UI description 201 to differentiate these cases. In some implementations, the type attributes of the UI elements are extracted from the UI structure description file, such as HTML metadata. Considering that different websites, applications and/or programming languages have different definitions for the type attributes of UI elements, for the purpose of simplification, the types of the UI elements may be normalized to some predetermined types. For example, a type of a UI element may be selected as one of the following four types: input, clickable, text, and image.

In some implementations, in order to distinguish which UIs the UI element comes from, the UI description 201 may further indicate the relative navigation numbers 218 of the corresponding UIs of the UI elements in the navigation path. The relative navigation numbers 218 may also be mapped into an embedding representation through the corresponding embedding layer.

The training data for the feature extraction model 210 has been described above. Pre-training of feature extraction model 210 is performed based on a correspondence between the UI descriptions 201, the task descriptions 203, and the plurality of navigation paths.

Generally, given the training data, one or more pre-training tasks can be designed to implement the pre-training of the model. The pre-trained model may be provided to perform any task. In the pre-training for UI navigation, input samples and supervision information of at least one navigation task may be determined from at least one of the UI descriptions, the task descriptions, and the plurality of navigation paths. Then, the input samples are inputted to the feature extraction model 210, and the parameter values of the feature extraction model 210 are updated according to the errors between the predicted outputs from the model and the supervision information. In this way, the feature extraction model 210 may be optimized iteratively until the errors are reduced to the expected value or minimized.

Note that although the UI descriptions 201 and task descriptions 203 are described above and are shown in the example in FIG. 2, depending on the design of the specific pre-training tasks, the information input to the feature extraction model 210 in different pre-training tasks may be different. In addition, depending on the design of the specific pre-training tasks, a task-specific output layer may also be connected to the feature extraction model 210. The task-specific output layer is used to receive the feature representation extracted from an input by the feature extraction model 210, and to determine, based on the feature representation, the predicted output for the specific pre-training task. The predicted output is used to optimize the parameter values of the feature extraction model 210 (and possibly the task-specific output layer 231) based on its error with the ground-truth output indicated by the supervision information.

In the following, four pre-training tasks for the feature extraction model 210 in UI navigation will be introduced. In different embodiments, any of the four training tasks and/or other training tasks may be selected to jointly implement the pre-training of the feature extraction model 210.

In some implementations, a first pre-training task includes UI element prediction guided by task descriptions. The input of the first pre-training task is a task description and a UI description corresponding to a navigation path, and the output is to predict a UI element selected from one or more given UIs in the navigation path which is selected to hop from each given UI to a next UI in the navigation path. In other words, the first pre-training task is to predict UI elements to be selected in respective UIs given the task description and the UI description. The selected UI elements in the navigation path can concatenate the UIs involved in the path.

To perform the pre-training using the first pre-training task, a first input sample of the feature extraction model 210 includes a task description 203 corresponding to a navigation path and a UI description 201 corresponding to this navigation path. First supervision information corresponding to the first input sample indicates a selected UI element in a UI in the navigation path which is selected to hop from the current UI to a next UI in the navigation path. For the purpose of training, a certain number of first input samples and corresponding first supervision information may be constructed from the plurality of identified navigation paths.

A task-specific output layer 231 may also be set for the first pre-training task. The task-specific output layer 231 is connected to the feature extraction model 210 to receive a feature representation extracted from an input sample by the feature extraction model 210, and to determine the predicted output based on the feature representation, i.e., respective probabilities that UI elements in a given UI belong to the selected UI element. The pre-training of the model is an iterative updating process. In each iteration of update, the parameter values of the model may be updated based on the errors between the current predicted outputs of task-specific output layer 231 and the first supervision information of the first input samples. The first pre-training objective of the first pre-training task may be configured to enable the pre-trained feature extraction model 210 to extract feature representations from task descriptions and UI descriptions corresponding to the navigation paths, which may be used to accurately predict the selected UI elements in the UI. In other words, after the iterative updating, the updated feature extraction model 210 and the task-specific output layer 231 may accurately predict the selected UI elements in the UIs, for example, with the prediction error falling within an allowed range or minimized.

In some implementations, a loss function for the first pre-training task may be determined to perform the pre-training of the feature extraction model 210. The loss function may be based on the cross-entropy (CE) loss. For the first pre-training task, the loss function L₁ may be represented as follows:

$${L}_{1} = CE ( y , \hat{y} ) \qquad ( 1 )$$

where CE ( ) represents the cross-entropy loss; y may be first supervision information corresponding to a first input sample, which may be in form of a one-hot vector with each element corresponding to a UI element in the UI where the selected UI element in a UI in a given navigation path is assigned with the value of 1 and the other elements may be assigned with the value of 0; ŷ is the predicted output of the task-specific output layer 231, which is also in form of a vector including the same number of elements as y, each element indicating a probability that the corresponding UI element belongs to the selected UI element (for example, with a value from 0 to 1). The first pre-training objective of the first pre-training task is to minimize or reduce the loss value of the loss function L₁ to a predetermined threshold.

In some implementations, a second pre-training task includes prediction of a masked task description part. As mentioned above, a title of a UI is a good summarization of the UI. For a certain navigation path, if it attempts to mask the title of a certain UI and try to recover the masked title from the remaining unmasked UI titles, then the feature extraction model 210 may be encouraged to model the entire UI. Therefore, an input of the second pre-training task is a partially masked task description of a navigation path and the corresponding UI description of the navigation task, and an output is the prediction of the masked part in the task description. That is, the second pre-training task is, given a part of a task description of a navigation path (for example, a title of a given UI) is masked, to predict the masked part of the task description from the task description part corresponding to other UIs in the navigation path (for example, the titles of the other UIs) and the UI description corresponding to the navigation path.

To perform the pre-training using the second pre-training task, a second input sample of the feature extraction model 210 includes a UI description 201 corresponding to a navigation task and a task description 203 (which is actually the concatenation of the embedding representations corresponding to various types of information in the task description 203) where the text information 220, the type 222, and the relative navigation number 224 corresponding to a title of a UI in the task description 203 are masked. For example, the part corresponding to the text information 220, the type 222, and the relative navigation number 224 are marked with a special symbol (for example, [MASK]). Second supervision information corresponding to the second input sample is a feature representation corresponding to the UI description 201 and the unmasked full task description 203. This feature representation may be extracted from the UI description 201 and the task description 203, for example, by other trained feature extraction models, such as a SentenceBert model. For purpose of training, a certain number of second input samples and corresponding second supervision information may be constructed from the plurality of identified navigation paths.

For the second pre-training task, a second input sample may be input into the feature extraction model 210 to extract the corresponding feature representation. Then, the parameters of feature extraction model 210 are updated based on the error between the feature representation extracted from the UI description 201 and the partially masked task description 203 by the feature extraction model 210 and the feature representation extracted from the UI description 201 and the full task description 203. No additional task-specific output layer is set in the second pre-training task. The second pre-training objective of the second pre-training task is configured in such a way that if a part of a task description is masked, the masked part of the task description can be predicted from the unmasked part of the task description and the UI description using the pre-trained feature extraction model. That is, it is expected that the errors between the feature representations extracted by the feature extraction model 210 and the feature representations indicated by the second supervision information are within an allowed range or can be minimized.

In some implementations, a loss function for the second pre-training task may be determined to perform the pre-training of the feature extraction model 210. The loss function may be based on the cross-entropy (CE) loss. For the second pre-training task, the loss function L₂ may be represented as follows:

$${L}_{2} = {‖ f ( t ) - g ( \tilde{t} ) ‖}_{2}^{2} \qquad ( 2 )$$

where t represents the full task description 203 and the UI description 201 corresponding to a navigation path; \tilde{t} indicates the partially masked task description 203 and the complete UI description 201; f(⋅) represents the trained feature extraction model, such as the SentenceBert model, which is used to extract the feature representation from t as the supervision information; g(⋅) represents the feature extraction model 210 for extracting the feature representation from \tilde{t}. The second pre-training objective of the second pre-training task is to minimize or reduce the loss value of the loss function L₂ to a predetermined threshold.

In some implementations, a third pre-training task includes prediction of a masked UI description. The UI description 201 may include text information 211 of UI elements. Similar to the task description of the navigation task, it may attempt to mask a part of the text information of all the UI elements in a UI description 201, and try to recover the masked part from the remaining masked UI description 201. In this way, the feature extraction model 210 may be encouraged to model each UI element in the UIs. Therefore, an input of the third pre-training task is a task description and a partially masked UI description corresponding to a certain UI navigation path, and the output is to predict the masked part of the UI description. That is, the third pre-training task is, given a part of the text information (for example, the text information of some UI elements) in a UI description corresponding to a navigation path is masked, to predict the masked part of the UI description from the unmasked part of the UI description and the task description.

To perform the pre-training using the third pre-training task, a third input sample of the feature extraction model 210 includes a task description 203 and a UI description 201 ((which is actually the concatenation of the embedding representations corresponding to various types of information in the UI description 201) corresponding to a navigation task, where the text information 211 corresponding to some UI elements of the UI description 201 is masked with a special symbol (for example, [MASK]). In some examples, the masked UI elements may be randomly selected with a certain proportion, and the embodiments of the subject matter described herein are not limited in this regard. Third supervision information corresponding to the third input sample is A feature representation corresponding to the task description 203 and the unmasked full UI description 201. The feature representation may be extracted by other trained feature extraction models, such as the SentenceBert model. For purpose of training, a certain number of third input samples and corresponding third supervision information may be constructed from the plurality of identified navigation paths.

For the third pre-training task, a third input sample may be input into the feature extraction model 210 to extract the corresponding feature representation. Then, the parameters of the feature extraction model 210 are updated based on the error between the feature representation extracted from the task description 203 and the partially masked UI description 201 by the feature extraction model 210 and the feature representation extracted from the full UI description 201 and the task description 203. No additional task-specific output layer is set in the third pre-training task. The third pre-training objective of the third pre-training task is configured in such a way that if a part of a UI description to be partially masked in the UI description, the masked part is predicted from the unmasked part of the task description and UI description using the pre-trained feature extraction model. That is, the error between the feature representation extracted by the desired feature extraction model 210 and the feature representation indicated by the third supervision information is within an allowed range or can be minimized.

In some implementations, a loss function for the third pre-training task may be determined to perform the pre-training of the feature extraction model 210. The loss function may be based on the cross-entropy (CE) loss. For the third pre-training task, the loss function L₃ may be represented as follows:

$${L}_{3} = {\sum }_{x ∈ M} {‖ f ( x ) - g ( \tilde{x} ) ‖}_{2}^{2} \qquad ( 3 )$$

where x represents the full UI description 201 and the full task description 203 corresponding to a navigation path; \tilde{x} represents the partially masked UI description 201 and the full task description 203 corresponding to the navigation path; f(⋅) represents the trained feature extraction model, such as the SentenceBert model, which is used to extract the feature representation from x as the supervision information; g(⋅) represents the feature extraction model 210 for extracting the feature representation from \tilde{x}; M is the number of masked UI elements in the UI description 201. The third pre-training objective of the third pre-training task is to minimize or reduce the loss value of the loss function L₃ to a predetermined threshold.

In some implementations, a fourth pre-training task includes trace identification of a navigation path. This pre-training task is to enable the feature extraction model 210 to learn more knowledge at the path level. The fourth pre-training task is to enable the feature extraction model 210 to predict whether two or more UIs belong to a same navigation path, or whether they belong to a shortest navigation path (i.e., a trace). An input of the fourth pre-training task may include UI descriptions corresponding to at least two UIs and a task description corresponding to a navigation path for one of the UIs. The output is to predict whether the at least two UIs belong to the same navigation path. That is, the fourth pre-training task is, given any two or more UIs, to determine whether those two or more UIs belong to an expected navigation path. For a certain website, if the link between two pages is considered as the shortest path, these two pages may be identified as the start UI and the end UI in the navigation path in the training data preparation phase.

To perform the pre-training using the fourth pre-training task, fourth input samples of the feature extraction model 210 includes UI descriptions corresponding to two or more UIs selected from a same navigation path (which is a positive sample for training) and a task description corresponding to the navigation path, and UI descriptions corresponding to two or more UIs randomly selected from different navigation paths (which is a negative sample for training), and a task descriptions corresponding to a certain navigation path. Fourth supervision information corresponding to a fourth input sample indicates whether the UIs in the input sample belongs to the same navigation path or not. For purpose of training, a certain number of fourth input samples and corresponding fourth supervision information may be built from the plurality of identified navigation paths.

A task-specific output layer 232 may also be set for the fourth pre-training task. The task-specific output layer 232 is connected to the feature extraction model 210 to receive a feature representation extracted from the fourth input sample by the feature extraction model 210, and to calculate the predicted output based on the feature representation, that is, the probability that the current input UIs belongs to the same navigation path. During each iteration update of the model pre-training process, the parameter values of the model may be updated based on the error between the current predicted output of the task-specific output layer 232 and the fourth supervision information of the fourth input sample. The fourth pre-training objective of the fourth pre-training task is configured in such a way to enable the pre-trained feature extraction model to extract the feature representation from the UI descriptions corresponding to the at least two UIs and the task description corresponding to the navigation pat, which may be used to accurately predict whether at least two UIs belong to the same navigation path. In other words, after the iterative updating, the updated feature extraction model 210 and the task-specific output layer 232 may accurately predict whether a plurality of input UIs belong to the same navigation path, for example, with the predicted error falling within an allowed range or minimized.

In some implementations, a loss function for the fourth pre-training task may be determined to perform the pre-training of the feature extraction model 210. The loss function may be based on the binary CE loss. For the fourth pre-training task, the loss function L₄ may be represented as follows:

$${L}_{4} = CE ( {y}_{w} , {\hat{y}}_{w} ) \qquad ( 4 )$$

where CE ( ) represents the cross-entropy loss; y_{w} may be the ground-truth output of fourth supervision information corresponding to a fourth input sample; ŷ_{w} is the predicted output of the task-specific output layer 232. The fourth pre-training objective of the fourth pre-training task is to minimize or reduce the loss value of the loss function L₄ to a predetermined threshold.

In some implementations, if the above first to fourth pre-training tasks are used for joint pre-training of the feature extraction model 210, the total pre-training objective of the feature extraction model 210 may be represented as minimizing or reducing the sum (or weighted sum) of the loss values of the above four loss functions to a predetermined threshold, which may be represented as follows:

$$L = {1}_{\{ {y}_{w} = 1 \}} {L}_{1} + {L}_{2} + {L}_{3} + {L}_{4} \qquad ( 5 )$$

where 1_{(⋅)} is an indicator function and y_{w} represents the supervision information of the fourth pre-training task. The pre-training objective of the feature extraction model 210 is to minimize or reduce the loss value of the loss function L in Equation (5) to a predetermined threshold.

It would be appreciated that although some pre-training tasks have been described above, any other appropriate pre-training tasks may be designed based on the navigation paths, the UI descriptions and the task descriptions (and possibly other training data) to perform the pre-training of the feature extraction model 210, which is not limited by the implementations of the subject matter described herein.

In some implementations, the pre-trained feature extraction model 210 may be provided for model fine-tuning using training data related to specific navigation tasks in the downstream specific navigation tasks. Since the feature extraction model 210 can learn more knowledge at the navigation path level from the training data in the pre-training stage, this model can be generalized to more downstream navigation tasks. In the downstream tasks, since more knowledge have been provided for the feature extraction model 210 to learn in the pre-training stage, the model have achieved great performance such that only a few training data is required for fine-tuning in the downstream to meet the use requirements of the downstream tasks.

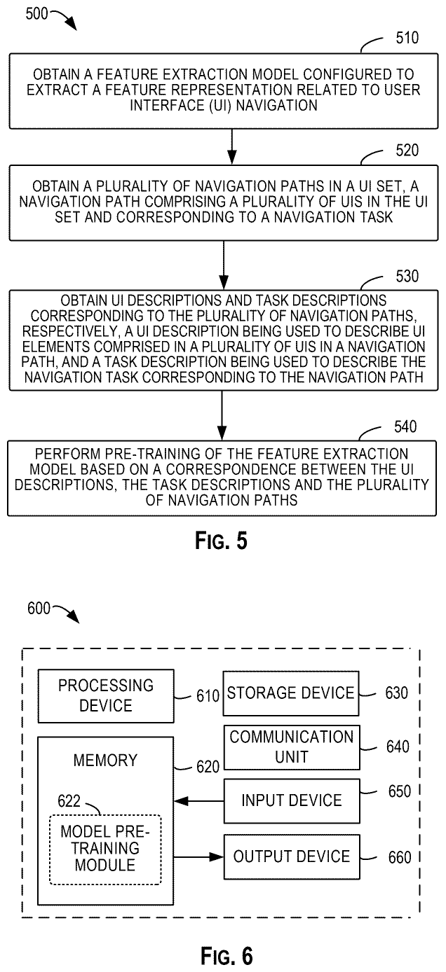

FIG. 5 shows a flowchart of a process 500 for model pre-training in accordance with some implementations of the subject matter described herein. The process 500 may be implemented at the model pre-training system 200 of FIG. 2.

At block 510, the model pre-training system 200 obtains a feature extraction model configured to extract a feature representation related to user interface (UI) navigation.

At block 520, the model pre-training system 200 obtains a plurality of navigation paths in a UI set, a navigation path comprising a plurality of UIs in the UI set and corresponding to a navigation task.

In block 530, the model pre-training system 200 obtains UI descriptions and task descriptions corresponding to the plurality of navigation paths, respectively, a UI description being used to describe UI elements comprised in a plurality of UIs in a navigation path, and a task description being used to describe the navigation task corresponding to the navigation path.

At block 540, the model pre-training system 200 performs pre-training of the feature extraction model based on a correspondence between the UI descriptions, the task descriptions and the plurality of navigation paths.

In some implementations, obtaining the plurality of navigation paths comprises: obtaining a navigation graph for the UI set, the navigation graph comprising nodes corresponding to UIs and directed edges between the nodes, and a directed edge from a first node to a second node indicating that a UI corresponding to the second node is able to be navigated to from a UI corresponding to the first node; searching for a plurality of paths from the navigation graph using a shortest path search algorithm, the plurality of paths having end nodes corresponding to UIs at which navigation tasks can be completed; and determining the plurality of navigation paths based on UIs corresponding to nodes in the plurality of paths.

In some implementations, searching for the plurality of paths from the navigation graph comprises: searching for the plurality of paths from the navigation graph using the shortest path search algorithm by taking a given UI corresponding to a home page in the UI set as a starting node of the navigation graph.

In some implementations, obtaining the task descriptions comprises: for a given navigation path of the plurality of navigation paths, obtaining a plurality of titles of a plurality of UIs in the given navigation path; and generating a task description corresponding to the given navigation path at least based on the plurality of titles, the task description indicating the plurality of titles and relative navigation numbers of the plurality of titles in the given navigation path.

In some implementations, the task description corresponding to the given navigation path further indicates type information indicating a type of title.

In some implementations, obtaining the UI descriptions comprises: for a given navigation path of the plurality of navigation paths, determining a set of UI elements in a plurality of UIs in the given navigation path; and for a given UI element in the set of UI elements, determining a UI description to indicate at least one of the following for the given UI element: text information, location information in a corresponding UI, image information, type information, or a relative navigation number of the corresponding UI in the given navigation path.

In some implementations, performing pre-training of the feature extraction model comprises: performing pre-training of the feature extraction model according to a first pre-training objective, the first pre-training objective being configured to enable the pre-trained feature extraction model to extract a feature representation from a task description and a UI description corresponding to a navigation path, the feature representation used to predict a UI element in a given UI of the navigation path which is selected to hop from the given UI to a next UI in the navigation path.

In some implementations, performing pre-training of the feature extraction model comprises: performing pre-training of the feature extraction model according to a second pre-training objective, the second pre-training objective being configured to, in a case that a part of a task description corresponding to a navigation path is masked, predict the masked part of the task description from an unmasked part of the task description and a UI description corresponding to the navigation path using the pre-trained feature extraction model.

In some implementations, the UI description comprises text information of UI elements, and performing pre-training of the feature extraction model comprises: performing pre-training of the feature extraction model according to a third pre-training objective, the third pre-training objective being configured to, in a case that a part of the text information of a UI description corresponding to a navigation path is masked, predict the masked part of the text information from the task description corresponding to the navigation path and an unmasked part of the UI description using the pre-trained feature extraction model.

In some implementations, performing pre-training of the feature extraction model comprises: performing pre-training of the feature extraction model according to a fourth pre-training objective, the fourth pre-training objective being configured to extract, using the pre-trained feature extraction model, a feature representation from a UI description corresponding to a first UI, a UI description corresponding to a second UI, and a task description corresponding to the navigation path where the second UI is located, the feature representation being used to predict whether the first UI and the second UI are in a same navigation path.

FIG. 6 illustrates a schematic block diagram of an electronic device in which various implementations of the subject matter described herein can be implemented. It would be appreciated that the electronic device 600 as shown in FIG. 6 is merely provided as an example, without suggesting any limitation to the functionalities and scope of implementations of the subject matter described herein.

As shown in FIG. 6, the electronic device 600 is in form of a general-purpose computing device. Components of the electronic device 600 may include, but are not limited to, one or more processors or processing devices 610, a memory 620, a storage device 630, one or more communication units 640, one or more input devices 650, and one or more output devices 660.

In some implementations, the electronic device 600 may be implemented as a device with computing capability, such as a computing device, a computing system, a server, a mainframe and the like.

The processing device 610 can be a physical or virtual processor and can execute various processing based on the programs stored in the memory 620. In a multi-processor system, a plurality of processing units execute computer-executable instructions in parallel so as to enhance parallel processing capability of the electronic device 600. The processing device 610 may include a central processing unit (CPU), a graphics processing unit (GPU), a microprocessor, a controller, and/or a microcontroller.

The electronic device 600 usually includes various computer storage media. Such media may be any available media accessible by the electronic device 600, including but not limited to, volatile and non-volatile media, or detachable and non-detachable media. The memory 620 may be a volatile memory (for example, a register, cache, Random Access Memory (RAM)), non-volatile memory (for example, a Read-Only Memory (ROM), Electrically Erasable Programmable Read-Only Memory (EEPROM), a flash memory), or any combination thereof. The storage device 630 may be any detachable or non-detachable medium and may include computer-readable medium such as a memory, a flash memory drive, a magnetic disk or any other media that can be used for storing information and/or data and are accessible by the electronic device 600.

The electronic device 600 may further include additional detachable/non-detachable, volatile/non-volatile memory media. Although not shown in FIG. 6, there may be provided a disk drive for reading from or writing into a detachable and non-volatile disk, and an optical disk drive for reading from and writing into a detachable non-volatile optical disc. In such cases, each drive may be connected to a bus (not shown) via one or more data medium interfaces.

The communication unit 640 implements communication with another computing device via the communication medium. In addition, the functionalities of components in the electronic device 600 may be implemented by a single computing cluster or a plurality of computing machines that can communicate with each other via communication connections. Thus, the electronic device 600 may operate in a networked environment using a logic connection with one or more other servers, network personal computers (PCs), or further general network nodes.

The input device 650 may include one or more of a variety of input devices, such as a mouse, keyboard, data import device and the like. The output device 660 may be one or more output devices, such as a display, data export device and the like. By means of the communication unit 640, the electronic device 600 may further communicate with one or more external devices (not shown) such as storage devices and display devices, one or more devices that enable the user to interact with the electronic device 600, or any devices (such as a network card, a modem and the like) that enable the electronic device 600 to communicate with one or more other computing devices, if required. Such communication may be performed via input/output (I/O) interfaces (not shown).

In some implementations, as an alternative of being integrated on a single device, some or all components of the electronic device 600 may also be arranged in the form of cloud computing architecture. In the cloud computing architecture, the components may be provided remotely and work together to implement the functionalities described in the subject matter described herein. In some implementations, cloud computing provides computing, software, data access and storage service, which will not require end users to be aware of the physical locations or configurations of the systems or hardware provisioning these services. In various implementations, the cloud computing provides the services via a wide area network (such as Internet) using proper protocols. For example, a cloud computing provider provides applications over the wide area network, which may be accessed through a web browser or any other computing components. The software or components of the cloud computing architecture and corresponding data may be stored in a server at a remote position. The computing resources in the cloud computing environment may be aggregated or distributed at locations of remote data centers. Cloud computing infrastructure may provide the services through a shared data center, though they behave as a single access point for the users. Therefore, the cloud computing infrastructure may be utilized to provide the components and functionalities described herein from a service provider at remote locations. Alternatively, they may be provided from a conventional server or may be installed directly or otherwise on a client device.

The electronic device 600 may be used to implement resource management in accordance with various implementations of the subject matter described herein. The memory 620 may include one or more modules having one or more program instructions. These modules may be accessed and run by the processing unit 610 to perform functions of various implementations described herein. For example, the memory 620 may include a model pre-training module 622 for performing model pre-training in various implementation of the subject matter described herein. As shown in FIG. 6, the electronic device 600 may obtain an input required for model pre-training through the input device 660 and provide the corresponding output through the output device 660. In some implementations, the electronic device 600 may further receive an input from other devices (not shown) via the communication unit 640.

Some example implementations of the subject matter described herein are listed below.

In an aspect, the subject matter described herein provides a computer-implemented method. The method comprises: obtaining a feature extraction model configured to extract a feature representation related to user interface (UI) navigation; obtaining a plurality of navigation paths in a UI set, a navigation path comprising a plurality of UIs in the UI set and corresponding to a navigation task; obtaining UI descriptions and task descriptions corresponding to the plurality of navigation paths, respectively, a UI description being used to describe UI elements comprised in a plurality of UIs in a navigation path, and a task description being used to describe the navigation task corresponding to the navigation path; and performing pre-training of the feature extraction model based on a correspondence between the UI descriptions, the task descriptions, and the plurality of navigation paths.

In some implementations, obtaining the plurality of navigation paths comprises: obtaining a navigation graph for the UI set, the navigation graph comprising nodes corresponding to UIs and directed edges between the nodes, and a directed edge from a first node to a second node indicating that a UI corresponding to the second node is able to be navigated to from a UI corresponding to the first node; searching for a plurality of paths from the navigation graph using a shortest path search algorithm, the plurality of paths having end nodes corresponding to UIs at which navigation tasks can be completed; and determining the plurality of navigation paths based on UIs corresponding to nodes in the plurality of paths.

In some implementations, searching for the plurality of paths from the navigation graph comprises: searching for the plurality of paths from the navigation graph using the shortest path search algorithm by taking a given UI corresponding to a home page in the UI set as a starting node of the navigation graph.

In some implementations, obtaining the task descriptions comprises: for a given navigation path of the plurality of navigation paths, obtaining a plurality of titles of a plurality of UIs in the given navigation path; and generating a task description corresponding to the given navigation path at least based on the plurality of titles, the task description indicating the plurality of titles and relative navigation numbers of the plurality of titles in the given navigation path.

In some implementations, the task description corresponding to the given navigation path further indicates type information indicating a type of title.

In some implementations, obtaining the UI descriptions comprises: for a given navigation path of the plurality of navigation paths, determining a set of UI elements in a plurality of UIs in the given navigation path; and for a given UI element in the set of UI elements, determining a UI description to indicate at least one of the following for the given UI element: text information, location information in a corresponding UI, image information, type information, or a relative navigation number of the corresponding UI in the given navigation path.

In some implementations, performing pre-training of the feature extraction model comprises: performing pre-training of the feature extraction model according to a first pre-training objective, the first pre-training objective being configured to enable the pre-trained feature extraction model to extract a feature representation from a task description and a UI description corresponding to a navigation path, the feature representation used to predict a UI element in a given UI of the navigation path which is selected to hop from the given UI to a next UI in the navigation path.

In some implementations, performing pre-training of the feature extraction model comprises: performing pre-training of the feature extraction model according to a second pre-training objective, the second pre-training objective being configured to, in a case that a part of a task description corresponding to a navigation path is masked, predict the masked part of the task description from an unmasked part of the task description and a UI description corresponding to the navigation path using the pre-trained feature extraction model.

In some implementations, the UI description comprises text information of UI elements, and performing pre-training of the feature extraction model comprises: performing pre-training of the feature extraction model according to a third pre-training objective, the third pre-training objective being configured to, in a case that a part of the text information of a UI description corresponding to a navigation path is masked, predict the masked part of the text information from the task description corresponding to the navigation path and an unmasked part of the UI description using the pre-trained feature extraction model.

In some implementations, performing pre-training of the feature extraction model comprises: performing pre-training of the feature extraction model according to a fourth pre-training objective, the fourth pre-training objective being configured to extract, using the pre-trained feature extraction model, a feature representation from a UI description corresponding to a first UI, a UI description corresponding to a second UI, and a task description corresponding to the navigation path where the second UI is located, the feature representation being used to predict whether the first UI and the second UI are in a same navigation path.

In another aspect, the subject matter described herein provides an electronic device. The electronic device comprises a processor; and a memory coupled to the processor and comprising instructions stored thereon which, when executed by the processor, cause the device to perform acts comprising: obtaining a feature extraction model configured to extract a feature representation related to user interface (UI) navigation; obtaining a plurality of navigation paths in a UI set, a navigation path comprising a plurality of UIs in the UI set and corresponding to a navigation task; obtaining UI descriptions and task descriptions corresponding to the plurality of navigation paths, respectively, a UI description being used to describe UI elements comprised in a plurality of UIs in a navigation path, and a task description being used to describe the navigation task corresponding to the navigation path; and performing pre-training of the feature extraction model based on a correspondence between the UI descriptions, the task descriptions, and the plurality of navigation paths.

In some implementations, obtaining the plurality of navigation paths comprises: obtaining a navigation graph for the UI set, the navigation graph comprising nodes corresponding to UIs and directed edges between the nodes, and a directed edge from a first node to a second node indicating that a UI corresponding to the second node is able to be navigated to from a UI corresponding to the first node; searching for a plurality of paths from the navigation graph using a shortest path search algorithm, the plurality of paths having end nodes corresponding to UIs at which navigation tasks can be completed; and determining the plurality of navigation paths based on UIs corresponding to nodes in the plurality of paths.

In some implementations, searching for the plurality of paths from the navigation graph comprises: searching for the plurality of paths from the navigation graph using the shortest path search algorithm by taking a given UI corresponding to a home page in the UI set as a starting node of the navigation graph.

In some implementations, obtaining the task descriptions comprises: for a given navigation path of the plurality of navigation paths, obtaining a plurality of titles of a plurality of UIs in the given navigation path; and generating a task description corresponding to the given navigation path at least based on the plurality of titles, the task description indicating the plurality of titles and relative navigation numbers of the plurality of titles in the given navigation path.

In some implementations, the task description corresponding to the given navigation path further indicates type information indicating a type of title.

In some implementations, obtaining the UI descriptions comprises: for a given navigation path of the plurality of navigation paths, determining a set of UI elements in a plurality of UIs in the given navigation path; and for a given UI element in the set of UI elements, determining a UI description to indicate at least one of the following for the given UI element: text information, location information in a corresponding UI, image information, type information, or a relative navigation number of the corresponding UI in the given navigation path.

In some implementations, performing pre-training of the feature extraction model comprises: performing pre-training of the feature extraction model according to a first pre-training objective, the first pre-training objective being configured to enable the pre-trained feature extraction model to extract a feature representation from a task description and a UI description corresponding to a navigation path, the feature representation used to predict a UI element in a given UI of the navigation path which is selected to hop from the given UI to a next UI in the navigation path.

In some implementations, performing pre-training of the feature extraction model comprises: performing pre-training of the feature extraction model according to a second pre-training objective, the second pre-training objective being configured to, in a case that a part of a task description corresponding to a navigation path is masked, predict the masked part of the task description from an unmasked part of the task description and a UI description corresponding to the navigation path using the pre-trained feature extraction model.

In some implementations, the UI description comprises text information of UI elements, and performing pre-training of the feature extraction model comprises: performing pre-training of the feature extraction model according to a third pre-training objective, the third pre-training objective being configured to, in a case that a part of the text information of a UI description corresponding to a navigation path is masked, predict the masked part of the text information from the task description corresponding to the navigation path and an unmasked part of the UI description using the pre-trained feature extraction model.

In some implementations, performing pre-training of the feature extraction model comprises: performing pre-training of the feature extraction model according to a fourth pre-training objective, the fourth pre-training objective being configured to extract, using the pre-trained feature extraction model, a feature representation from a UI description corresponding to a first UI, a UI description corresponding to a second UI, and a task description corresponding to the navigation path where the second UI is located, the feature representation being used to predict whether the first UI and the second UI are in a same navigation path.

In yet another aspect, the subject matter described herein provides a computer program product that is tangibly stored in a computer storage medium and comprises computer executable instructions that, when executed by a device, cause the device to perform any operations of the method in the above aspect.

In yet another aspect, the subject matter described herein provides a computer-readable medium having computer executable instructions stored thereon that, when executed by a device, cause the device to perform any operations of the method in the above aspect.

The functionalities described herein can be performed, at least in part, by one or more hardware logic components. As an example, and without limitation, illustrative types of hardware logic components that can be used include field-programmable gate arrays (FPGAs), Application-specific Integrated Circuits (ASICs), application-specific standard products (ASSPs), system-on-a-chip systems (SOCs), complex programmable logic devices (CPLDs), and the like.

Program code for carrying out the methods of the subject matter described herein may be written in any combination of one or more programming languages. The program code may be provided to a processor or controller of a general-purpose computer, special purpose computer, or other programmable data processing flowchart such that the program code, when executed by the processor or controller, causes the functions/operations specified in the flowcharts and/or block diagrams to be implemented. The program code may be executed entirely or partly on a machine, executed as a stand-alone software package partly on the machine, partly on a remote machine, or entirely on the remote machine or server.

In the context of the subject matter described herein, a machine-readable medium may be any tangible medium that may contain or store a program for use by or in connection with an instruction execution system, flowchart, or device. The machine-readable medium may be a machine-readable signal medium or a machine-readable storage medium. A machine-readable medium may include but is not limited to an electronic, magnetic, optical, electromagnetic, infrared, or semiconductor system, flowchart, or device, or any suitable combination of the foregoing. More specific examples of the machine-readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations are performed in the particular order shown or in sequential order, or that all illustrated operations are performed to achieve the desired results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular implementations. Certain features that are described in the context of separate implementations may also be implemented in combination in a single implementation. Rather, various features described in a single implementation may also be implemented in various implementations separately or in any suitable sub-combination.

Although the subject matter has been described in language specific to structural features and/or methodological acts, it is to be understood that the subject matter specified in the appended claims is not necessarily limited to the specific features or acts described above. Rather, the specific features and acts described above are disclosed as example forms of implementing the claims.

1-15. (canceled)

16. A computer-implemented method comprising:
obtaining a feature extraction model configured to extract a feature representation related to user interface (UI) navigation;
obtaining a plurality of navigation paths in a UI set, a navigation path comprising a plurality of UIs in the UI set and corresponding to a navigation task;
obtaining UI descriptions and task descriptions corresponding to the plurality of navigation paths, respectively, a UI description being used to describe UI elements comprised in a plurality of UIs in a navigation path, and a task description being used to describe the navigation task corresponding to the navigation path; and
performing pre-training of the feature extraction model based on a correspondence between the UI descriptions, the task descriptions, and the plurality of navigation paths.

17. The method of claim 16, wherein obtaining the plurality of navigation paths comprises:
obtaining a navigation graph for the UI set, the navigation graph comprising nodes corresponding to UIs and directed edges between the nodes, and a directed edge from a first node to a second node indicating that a UI corresponding to the second node is able to be navigated to from a UI corresponding to the first node;
searching for a plurality of paths from the navigation graph using a shortest path search algorithm, the plurality of paths having end nodes corresponding to UIs at which navigation tasks can be completed; and
determining the plurality of navigation paths based on UIs corresponding to nodes in the plurality of paths.

18. The method of claim 17, wherein searching for the plurality of paths from the navigation graph comprises:
searching for the plurality of paths from the navigation graph using the shortest path search algorithm by taking a given UI corresponding to a home page in the UI set as a starting node of the navigation graph.

19. The method of claim 16, wherein obtaining the task descriptions comprises: for a given navigation path of the plurality of navigation paths,
obtaining a plurality of titles of a plurality of UIs in the given navigation path; and
generating a task description corresponding to the given navigation path at least based on the plurality of titles, the task description indicating the plurality of titles and relative navigation numbers of the plurality of titles in the given navigation path.

20. The method of claim 19, wherein the task description corresponding to the given navigation path further indicates type information indicating a type of title.

21. The method of claim 16, wherein obtaining the UI descriptions comprises: for a given navigation path of the plurality of navigation paths,
determining a set of UI elements in a plurality of UIs in the given navigation path; and
for a given UI element in the set of UI elements, determining a UI description to indicate at least one of the following for the given UI element:
text information,
location information in a corresponding UI,
image information,
type information, or
a relative navigation number of the corresponding UI in the given navigation path.

22. The method of claim 16, wherein performing pre-training of the feature extraction model comprises:
performing pre-training of the feature extraction model according to a first pre-training objective,
the first pre-training objective being configured to enable the pre-trained feature extraction model to extract a feature representation from a task description and a UI description corresponding to a navigation path, the feature representation used to predict a UI element in a given UI of the navigation path which is selected to hop from the given UI to a next UI in the navigation path.

23. The method of claim 16, wherein performing pre-training of the feature extraction model comprises:
performing pre-training of the feature extraction model according to a second pre-training objective,
the second pre-training objective being configured to, in a case that a part of a task description corresponding to a navigation path is masked, predict the masked part of the task description from an unmasked part of the task description and a UI description corresponding to the navigation path using the pre-trained feature extraction model.

24. The method of claim 16, wherein the UI description comprises text information of UI elements, and performing pre-training of the feature extraction model comprises:
performing pre-training of the feature extraction model according to a third pre-training objective,
the third pre-training objective being configured to, in a case that a part of the text information of a UI description corresponding to a navigation path is masked, predict the masked part of the text information from the task description corresponding to the navigation path and an unmasked part of the UI description using the pre-trained feature extraction model.

25. The method of claim 16, wherein performing pre-training of the feature extraction model comprises:
performing pre-training of the feature extraction model according to a fourth pre-training objective,
the fourth pre-training objective being configured to extract, using the pre-trained feature extraction model, a feature representation from a UI description corresponding to a first UI, a UI description corresponding to a second UI, and a task description corresponding to the navigation path where the second UI is located, the feature representation being used to predict whether the first UI and the second UI are in a same navigation path.

26. An electronic device comprising:
a processor; and
a memory coupled to the processor and comprising instructions stored thereon which, when executed by the processor, cause the device to perform acts comprising:
obtaining a feature extraction model configured to extract a feature representation related to user interface (UI) navigation;
obtaining a plurality of navigation paths in a UI set, a navigation path comprising a plurality of UIs in the UI set and corresponding to a navigation task;
obtaining UI descriptions and task descriptions corresponding to the plurality of navigation paths, respectively, a UI description being used to describe UI elements comprised in a plurality of UIs in a navigation path, and a task description being used to describe the navigation task corresponding to the navigation path; and
performing pre-training of the feature extraction model based on a correspondence between the UI descriptions, the task descriptions, and the plurality of navigation paths.

27. The device of claim 26, wherein obtaining the plurality of navigation paths comprises:
obtaining a navigation graph for the UI set, the navigation graph comprising nodes corresponding to UIs and directed edges between the nodes, and a directed edge from a first node to a second node indicating that a UI corresponding to the second node is able to be navigated to from a UI corresponding to the first node;
searching for a plurality of paths from the navigation graph using a shortest path search algorithm, the plurality of paths having end nodes corresponding to UIs at which navigation tasks can be completed; and
determining the plurality of navigation paths based on UIs corresponding to nodes in the plurality of paths.

28. The device of claim 27, wherein searching for the plurality of paths from the navigation graph comprises:
searching for the plurality of paths from the navigation graph using the shortest path search algorithm by taking a given UI corresponding to a home page in the UI set as a starting node of the navigation graph.

29. The device of claim 26, wherein obtaining the task descriptions comprises: for a given navigation path of the plurality of navigation paths,
obtaining a plurality of titles of a plurality of UIs in the given navigation path; and
generating a task description corresponding to the given navigation path at least based on the plurality of titles, the task description indicating the plurality of titles and relative navigation numbers of the plurality of titles in the given navigation path.

30. The device of claim 29, wherein the task description corresponding to the given navigation path further indicates type information indicating a type of title.

31. The device of claim 26, wherein obtaining the UI descriptions comprises: for a given navigation path of the plurality of navigation paths,
determining a set of UI elements in a plurality of UIs in the given navigation path; and
for a given UI element in the set of UI elements, determining a UI description to indicate at least one of the following for the given UI element:
text information,
location information in a corresponding UI,
image information,
type information, or
a relative navigation number of the corresponding UI in the given navigation path.

32. The device of claim 26, wherein performing pre-training of the feature extraction model includes:
performing pre-training of the feature extraction model according to a first pre-training objective,
the first pre-training objective being configured to enable the pre-trained feature extraction model to extract a feature representation from a task description and a UI description corresponding to a navigation path, the feature representation used to predict a UI element in a given UI of the navigation path which is selected to hop from the given UI to a next UI in the navigation path.

33. The device of claim 26, wherein performing pre-training of the feature extraction model includes:
performing pre-training of the feature extraction model according to a second pre-training objective,
the second pre-training objective being configured to, in a case that a part of a task description corresponding to a navigation path is masked, predict the masked part of the task description from an unmasked part of the task description and a UI description corresponding to the navigation path using the pre-trained feature extraction model.

34. The device of claim 26, wherein performing pre-training of the feature extraction model includes:
performing pre-training of the feature extraction model according to a fourth pre-training objective,
the fourth pre-training objective being configured to extract, using the pre-trained feature extraction model, a feature representation from a UI description corresponding to a first UI, a UI description corresponding to a second UI, and a task description corresponding to the navigation path where the second UI is located, the feature representation being used to predict whether the first UI and the second UI are in a same navigation path.

35. A computer program product being tangibly stored in a computer storage medium and comprising computer executable instructions that, when executed by a device, cause the device to perform acts comprising:
obtaining a feature extraction model configured to extract a feature representation related to user interface (UI) navigation;
obtaining a plurality of navigation paths in a UI set, a navigation path comprising a plurality of UIs in the UI set and corresponding to a navigation task;
obtaining UI descriptions and task descriptions corresponding to the plurality of navigation paths, respectively, a UI description being used to describe UI elements comprised in a plurality of UIs in a navigation path, and a task description being used to describe the navigation task corresponding to the navigation path; and
performing pre-training of the feature extraction model based on a correspondence between the UI descriptions, the task descriptions, and the plurality of navigation paths.
